(19) United States
(12) Patent Application Publication
(10) Pub. No.: US 2006/0149682 A1
(43) Pub. Date: Jul. 6, 2006

(54) Disk device

(75) Inventor: Ryuji Ikeda, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/265,509

(22) Filed: Nov. 3, 2005

(30) Foreign Application Priority Data
Nov. 4, 2004 (JP) P.2004-320931

(51) Int. Cl. G06Q 99/00

(52) U.S. Cl. 705/57

(57) ABSTRACT

A disk device for recording required information in or reproducing recorded information from a disk type information recording medium including a read-in area, a user-data area and a read-out area and capable of recording genre of audiovisual information recorded in the user-data area in a block of the read-in area as a text data, includes: an input unit for inputting instructions and information related to a recording information in and reproducing information from the disk type information recording medium; and a control unit for executing a control for stopping reproduction of audiovisual information corresponding to a genre when kind information of the genre inputted by an inputting operation of the input unit and preliminarily recorded in a memory as genre data coincides with kind information of the genre read out from the read-in area during reproduction of information of the disk type information memory medium.

### BACKGROUND OF THE INVENTION

1. Field of the Invention

The present invention relates to a disk device for limiting viewing of an information recorded in such as a DVD (Digital Versatile Disc) in reproducing the information and, in particular, to a disk device capable of limiting view of a program depending upon genre of the recorded information.

2. Description of the Related Art

A variety of reproduction devices capable of preventing child from viewing a program, which may give the child an unfavorable influence from the view point of child education, by performing a program view restriction during a reproduction of an optical disk have been proposed. As an example of these devices, a reproducing device, with which a rating of program is possible on the side of television receiver, has been known (cf. e.g. JP-A-2003-18550).

This reproducing device is constructed with a data read unit for reading data from an arbitrary recording medium, a video decoder unit for converting data from the data read unit into a video signal, an audio decoder unit for converting data from the data read unit into an audio signal and a control unit.

This control unit reads rating information of a program contained in the arbitrary medium and then sends it as a signal annexed to the video signal or the audio signal, so that an external device can corresponds to the rating information.

A recording medium reproducing device, which is capable of appropriately setting a view restriction level corresponding to viewing program scene according to a user's discretion, is also known. (cf. e.g. JP-A-2001-43630).

This recording medium reproducing device is constructed with a reproducing unit, a setting unit and a control unit.

In using this recording medium reproducing device, when a desired title is selected after a DVD is mounted, the control unit controls the DVD to reproduce presentation information from a head of the title by the reproducing unit.

During reproduction, the control unit monitors a producing position by referencing various reproducing control information, which is preliminarily read out from the DVD and stored, and temporarily stops the reproducing when the producing position comes to a view restriction period in the desired title.

When the user sets the view restriction level by means of the setting unit, the control unit restarts the reproduction of information, which clears the restriction level thus set, among a plurality of presentation information having different view restrictions and prepared within a view restriction range.

Thus, the user himself can view a scene with contents wanted by the user in the view restricted range.

A broadcast receiver capable of setting a view restriction level on the side of television receiver, a view restriction system and a recording medium are also known. (cf. e.g. JP-A-2001-145033).

This broadcast receiver includes a memory unit for storing condition information, which is set by a combination of channel number, time band and genre, compares channel selection information with the condition information stored in the memory unit and stops receiving of the selected channel when the channel selection information coincides with contents of the condition information.

Separately from the view restriction on the side of broadcasting station, the selection setting of restricted program can be made possible on the side of the receiving device and compares the setting with the condition information in the memory unit in recording or reproducing the program and stops the recording or reproducing of the program when the setting coincides with the contents of the condition information.

A contents reproducing device and a method thereof for managing a program viewing of a user more flexibly on the basis of a viewing restriction condition for every user in due consideration of genre of viewing program are known. (cf. e.g. JP-A-2001-339654).

The contents reproducing device includes a genre information acquisition unit for acquiring genre information of every program, a coefficient setting unit for setting weighting coefficient for every program genre and a calculation unit for calculating weighted viewing time by multiplying the viewing time of program and the weighting coefficient of genre belonging to the program.

The contents reproducing device further includes a hold unit for holding a sum of weighted viewing time for every user as a total view time and an allowance decision unit for deciding propriety of view by comparing the total view time for every user with the view restriction time for every user.

Since the contents reproducing device can manage the view restriction for each program genre as a unit, it is possible to exclude undesirable program or restrict the viewing thereof even when a plurality of programs belonging to different program genres are broadcasted on one and the same channel.

Incidentally, the reproducing device disclosed in JP-A-2003-18550 reproduces information on the basis of parental lock based on the rating of program and the recording medium reproducing device disclosed in JP-A-2001-43630 restarts reproduction of information, which clears a current setting level, among a plurality of presentation information having different view restrictions.

Each of these devices restricts the viewing by the parental lock. However, there are problems that the device can not restrict the viewing during a reproduction of a disk having no parental lock and that, when a disc reproducing device or a system has no parental lock function, the view restriction is impossible during the reproducing even when a disk can record parental lock.

Further, these devices of the parental lock system have complicated constructions and simple view restrictions are impossible.

Further, in the broadcast receiving device, the view restriction system and the recording medium disclosed in JP-A-2001-145033, the conditional information, which is set by the combination of channel number, time zone and genre, is stored in the memory unit and a receiving of a program in a selected channel is stopped when the conditional information in the memory portion coincides with the channel selection information.

The contents reproducing device and the method therefor disclosed in JP-A-2001-339654 manages the view restriction in program genre unit and excludes undesirable program or restrict the viewing thereof when a plurality of programs belonging to different program genres are broadcasted on one and the same channel.

As mentioned above, the techniques disclosed in JP-A-2001-145033 and JP-A-2001-339654 restrict the program viewing by not parental lock but genre and do not restrict the viewing during the reproducing by preliminarily recording genre information on a disk such as a DVD.

Since, therefore, there is no restriction in reproducing program, etc., recorded on the disk, the problem that the viewing restriction for preventing child from viewing the program is left as it is.

### SUMMARY OF THE INVENTION

The present invention was made in view of the above mentioned problems and an object of the present invention is to provide a disk device capable of easily restricting viewing by recording genre information together with view restriction of program, etc., on a disk during reproduction operation.

In order to achieve the above object, the disk device according to the present invention, for recording required information in or reproducing recorded information from a disk type information recording medium having a read-in area, a user data area and a read-out area and being capable of recording genre of audiovisual information recorded in the user-data area in a block of the read-in area as a text data, is characterized by comprising an input unit for inputting instructions and information related to information recording and reproducing of the disk-type information recording medium and a control unit for executing a control for stopping the reproduction of audiovisual information corresponding to a genre when kind information of genre inputted by an inputting operation of the input unit and preliminarily recorded in a memory as genre data coincides with the kind information of genre read out from the read-in area during reproduction of the information of the disk type information medium.

The disk device of the present invention is further characterized by comprising a display unit for displaying on a display screen a genre list and a discrimination sign for determining whether or not the program viewing of each genre in the genre list is restricted, wherein, when a genre display instruction is sent from the input unit, the control unit controls the display unit to display the genre list and the discrimination sign on the display screen and the genre information determined by the selection operation of the input unit is stored in the memory.

The disk device of the present invention is characterized by that the input unit includes a program viewing discrimination key for discriminating an instruction of program view restriction, the control unit responds to an instruction signal from the program view restriction key during an information reproduction of the disk type information recording medium to display the kind of genre of the reproducing information on the display screen and characters for prompting an input of a password and then, when an inputted password is authenticated, to store the genre information of the genre displayed in the memory.

As described hereinbefore, the disk device according to the present invention compares kind information of genre read out from the read-in area with genre data in reproducing the information of the disk type information medium and, when the information in the both areas are coincident, the reproduction of audiovisual information corresponding to the genre is stopped. Therefore, there is an advantage that the view restriction can be easily done even for a disk, which is unable to restrict the viewing by conventional parental lock system.

Further, in the disk device of the present invention, the genre information determined by the selection operation of the input unit is stored in the memory after the genre list and the discrimination sign displayed on the display screen of the input unit. Therefore, there is an advantage that it is possible to restrict viewing by selecting an arbitrary genre among a plurality of genres.

Further, in the disk device of the present invention, the kind of genre of the reproducing information, which is being displayed on the screen during the information of the disk type information recording medium is reproduced and then the kind information of the genre displayed is stored in the memory when an inputted password is authenticated. Therefore, there is a merit that the restricting operation for restricting the receiving of program can be easily performed while watching a reproduced video image.

### BRIEF DESCRIPTION OF THE DRAWINGS

These and other objects and advantages of this invention will become more fully apparent from the following detailed description taken with the accompanying drawings in which:

FIG. 1 is a block diagram showing an electrical construction of a disk device according an embodiment of the present invention;

FIG. 2 illustrates a data recording structure of a DVD;

FIG. 3 is a screen showing setting items of a menu displayed on a monitor;

FIG. 4 is a screen showing view restricted genre displayed on the monitor;

FIG. 5 is a screen showing content of warning displayed on the monitor;

FIG. 6 is a screen showing a password input displayed on the monitor; and

FIG. 7 is a flowchart for explaining a reproduction operation of the DVD.

### DETAILED DESCRIPTION OF THE PREFERRED EMBODIMENTS

Embodiments of the disk device according to the present invention will be described with reference to the attached drawings.

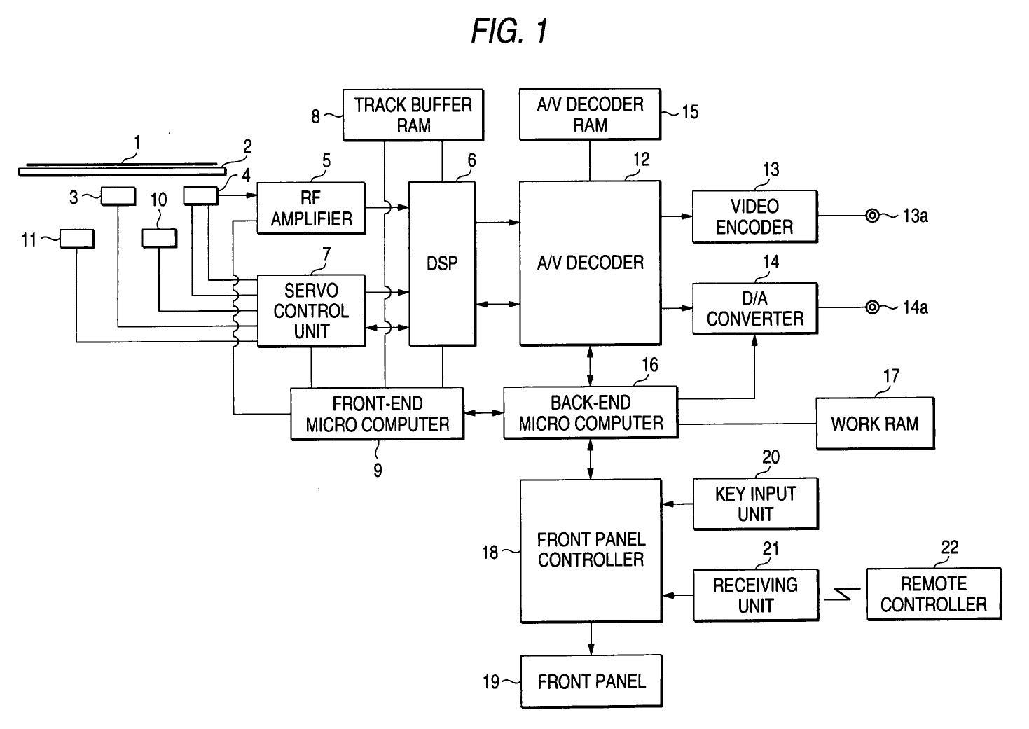

FIG. 1 is a block circuit diagram showing an embodiment of an electrical construction of the disk device according to the present invention.

The disk device according to this embodiment is applied to a DVD recorder and constructed such that information recorded on a DVD 1 is reproduced and is recorded with externally inputted information is recorded on the DVD 1 by operating a push key of a remote controller 22. Incidentally, in this description, a reproducing function of the disk device will be described mainly.

In FIG. 1, a reference numeral 2 depicts a disk tray on which the DVD 1 is mounted. The disk tray 2 is driven by a disk motor 3. Further, a reference numeral 4 depicts a photodetector, which outputs reproducing information optically read out from a track of the DVD 1 to an RF amplifier 5.

The RF amplifier 5 supplies the reproducing information to a DSP (Digital Signal Processor) 6 and a servo control unit 7. An output of a servo control unit 7 is supplied to the DSP 6.

The RF amplifier 5, the DSP 6 and the servo control unit 7, etc., are controlled by a micro computer 9 (referred to as “front end micro computer” hereinafter) for reproducing the information from the DVD 1.

A track buffer RAM 8 is connected to the DSP 6 and temporarily stores data, which is amplified by the RF amplifier 5 and decoded according to DVD standards (in this embodiment, compressed according to MPEG (Moving Picture Coding Experts Group)).

Further, the DSP 6 is connected to a video encoder 13 and a D/A converter 14 through an A/V (Audio/Video) decoder 12.

The servo control unit 7 controls a focus servo and a tracking servo with respect to the photodetector 4 according to commands and control data transmitted/received from the front end micro computer 9 through the DSP 6.

The servo control unit 7 further controls a sled motor 10 for moving the photodetector 4 in a radial direction of the DVD 1 and a tray motor 11 for driving the disk tray 2.

The A/V decoder 12 is connected to a micro computer (referred to as “back end micro computer”, hereinafter) 16 for controlling an output operation of various information reproduced by the DVD 1.

The A/V decoder 12 functions to expand the compressed data compressed according to MPEG and read out from the track buffer RAM 8.

Incidentally, an A/V decoding RAM 15 is connected to the A/V decoder 12 and stores data, which corresponds to several screens, among the digital data expanded as mentioned above.

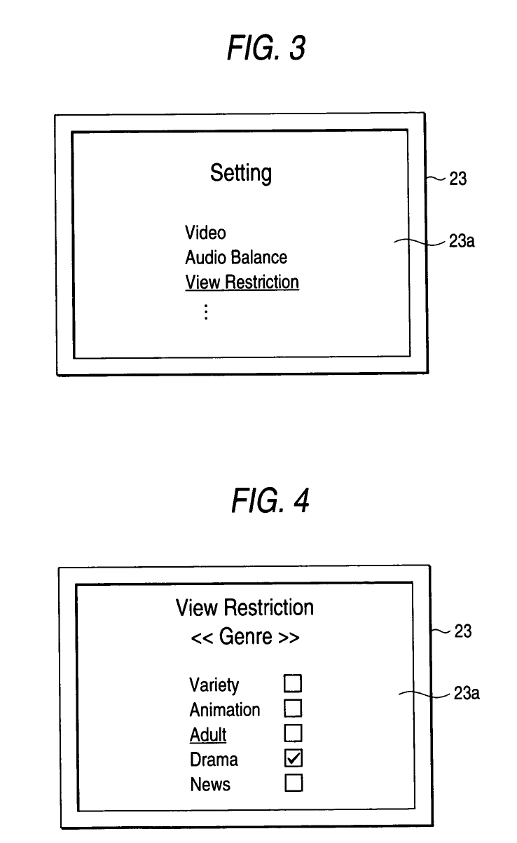

The video encoder 13 encodes the video data from the A/V decoder 12 and supplies the encoded video data to a monitor 23 shown in FIG. 3 through an output terminal 13a.

Further, a D/A converter 14 converts the audio data from the A/V decoder 12 into an analog signal and supplies the analog signal to a loud speaker (not shown) through an output terminal 14a.

Incidentally, an output of an OSD (On Screen Display) circuit (not shown) is supplied to the video encoder 13. The OSD circuit outputs an OSD signal to the video encoder 13 on the basis of a display control of the back end micro computer 16 to display various setting items on a screen 23a of the monitor 23 as menu.

The setting items include a setting of genre information in addition to basic setting items such as video image regulation and audio balance, etc., as shown in FIG. 3. The setting of the genre information is performed by an operation of a remote controller 22 or a key input unit 20.

Incidentally, the OSD circuit further performs a display of items such as view restriction, warning and password input related to reproduction in view restriction time as shown in FIG. 4 to FIG. 6. A reference numeral 16 depicts a back end micro computer connected to a work RAM 17 for storing various data. The work RAM 17 stores genre information from the remote controller 22 as genre data in predetermined areas thereof. The genre information includes VARIETY, ANIMATION, ADULT, DRAMA, MOVIE and NEWS, etc., corresponding to kinds preliminarily recorded in the DVD 1.

A front panel controller 18 is connected to the back end micro computer 16. The front panel controller 18 performs a control of a front panel 19 constructed with an LCD, etc., and is supplied with an output of a key input unit 20 and an output of a receiving unit 21, which receives an infrared transmission signal from the remote controller 22.

The remote controller 22 includes function keys in addition to the various operation keys similar to those of a popular DVD recorder. That is, the remote controller 22 includes a menu key for displaying MENU on the screen 23a of the monitor 23, a cursor key for reproduction function and selection of a menu item and a decision key for setting a selection contents, etc.

When the menu key is operated, menu items shown in FIG. 3 are displayed on the screen 23a of the monitor 23. When the cursor key is operated, any of the items is selected and, when the decision key is operated, the selected menu item is decided.

When genre among the menu items is selected, genres and check boxes are displayed on the screen 23a as shown in FIG. 4. When the cursor key is operated, a pointer is moved to any of the check boxes and, when the decision key is operated, the selected check box is checked to selectively decide a particular genre.

The remote controller 22 makes an input of the password possible while viewing the screen 23a of the monitor 23.

Further, the remote controller 22 includes a view restriction key though it is not shown. By pushing the view restriction key, an instruction signal indicative of the genre information, view of which is restricted during reproducing of the AV information, is generated.

The view restriction key may be provided separately or any other function key may be used as the view restriction key concurrently.

When any key of the remote controller 22 constructed as mentioned above is pushed, a signal corresponding thereto is transmitted to the DVD player through infrared ray.

Incidentally, the back-end micro computer 16 is bi-directionally connected to the front-end micro computer 9 in such a way that the operation of the whole disk device is controlled by the micro computers 9 and 16.

That is, upon the instruction signal from the key input unit 20 or the remote controller 22, the servo control unit 7 performs a control correspondingly to the content of the instruction to record the information in the read-in area, the user data area and the read-out area of the DVD 1 or reproduce information recorded therein.

Further, when the genre information related to the view restriction is inputted during the reproduction of information, the back-end micro computer 16 compares the genre information with the genre data in the work RAM 17 and, when they are coincident, the back-end micro computer 16 performs a control for blocking reproduction of the AV information of the same genre.

Further, it performs a control for storing and registering the password data from the remote controller 22 in the work RAM 17 and, when password data is sent during reproduction of information, performs a next operation control by authenticating the registered password.

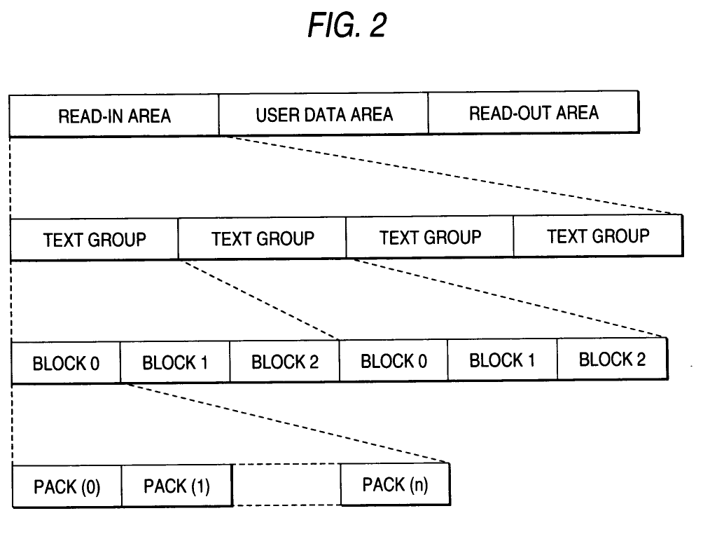

FIG. 2 shows a data recording structure of the DVD 1.

The DVD 1 includes the read-in area, the user data area and the read-out area and audiovisual information (AV information) of such as movie program is recorded in the user data area.

Addresses indicating fine points (positions) of a spiral recording track of the DVD 1, which are necessary to write the AV information in the user data area as digital data, are preliminarily provided in the DVD 1. The addresses correspond to a time elapsed from an initial recording position to a last recording position.

Further, in a TOC region of the read-in area, recording positions of chapters and titles are recorded as address data correspondingly to lapse time information from a recording start position (chapter No. 1 of title No. 1).

Therefore, when the data in the TOC region is read out, it is possible to display, on the screen 23a of the monitor 23, title number, chapter number of such as a movie, recording start and end positions and a detailed recording time, etc., which are recorded in the user data area of the recording track.

Further, a test data is recorded in this read-in area of the disk. The genre information for view restriction can be recorded as a sub code of the text data.

The sub code is a control display signal recorded together with the digital data and is composed of 8 channels P, Q, R, S, T, U, V and W.

The channels P and Q are used for control and display in usual reproduction and the text data is recorded in the 6 channels R. S, T, U, V and W.

During reproduction of the DVD 1, the information read out from the read-in area thereof is decoded and then the text data in the 6 channels is converted into 8-bit character information.

Therefore, it becomes possible to display the kind information of genre on the screen 23a of the monitor 23.

Incidentally, the text data are put together as a text data pack of 18 bytes and a text data block is constructed with a plurality of the packs, the maximum number of which is 256.

A text group is constructed with a plurality of text data blocks, the maximum number of which is 8, and recorded in the read-in area repeatedly.

Therefore, it is possible to record, in each block, the kind of genre information in addition to the kind of language. In this embodiment, the kinds VARIETY, ANIMATION, ADULT, DRAMA and NEWS are recorded as the genre information.

Incidentally, a data indicating an end of recording of the AV information is written in the read-out area.

Now, an operation of the DVD player will be described with reference to the drawings.

Here, a case where the DVD 1 recorded with a movie is reproduced will be described.

A movie is preliminarily recorded in the user data area of the DVD 1 as the AV information. Further, the genre information of ADLUT indicating movie for adult is recorded in the read-in area of the DVD 1.

A user who decides that a content of the movie is not suitable for a child preliminarily sets the view restriction.

First, when the user operates the menu key of the remote controller 22, the back-end micro computer 16 controls the OSD circuit according to the menu display instruction signal to display a menu of various setting items of menu on the screen 23a of the monitor 23 as shown in FIG. 3.

Then, when the user selects the view restriction among the various setting items by operating the cursor key and the decision key, the back-end micro computer 16 performs the control for displaying VARIETY, ANIMATION, ADULT, DRAMA and NEWS, etc., together with the check boxes on the screen 23a of the monitor 23 as shown in FIG. 4.

When the user checks the check box for ADULT, ADULT is decided as the genre, view of which is to be restricted.

Upon this determination, the back-end micro computer 16 controls to store the genre data of ADULT in a predetermined area of the work RAM 17.

When the DVD 1 is reproduced thereafter, a play key mounted on the tray of the DVD recorder is operated.

The back-end micro computer 16 is checking whether or not the disk is mounted (Step S11) and, when the DVD 1 is mounted in the predetermined position and there is the reproduction instruction, starts reading of the information in the recording track (Step S12).

First, when the text data in the read-in area is read out, it is sent to the back-end micro computer 16 through the DSP 6.

The back-end micro computer 16 determines, from the input information, whether or not the genre information is recorded in the sub code of the text data (Step S13).

When the genre information is not inputted, the reproduction of the AV information is started by the servo control portion 7 under control of the front-end micro computer 9 (Step S19).

Since the genre information is preliminarily recorded in the DVD 1, the genre information is compared with the genre data in the work RAM 17 (Step S14).

Thereafter, the back-end micro computer 16 determines whether or not the viewing of the genre information is to be restricted (Step S15).

Since, in this case, the genre data of ADULT is stored in the work RAM 17, the back-end micro computer 16 decides that these information are coincident.

Incidentally, when the genre data of ADULT is not stored in the work RAM 17, the reproduction of the AV information is started (Step S19).

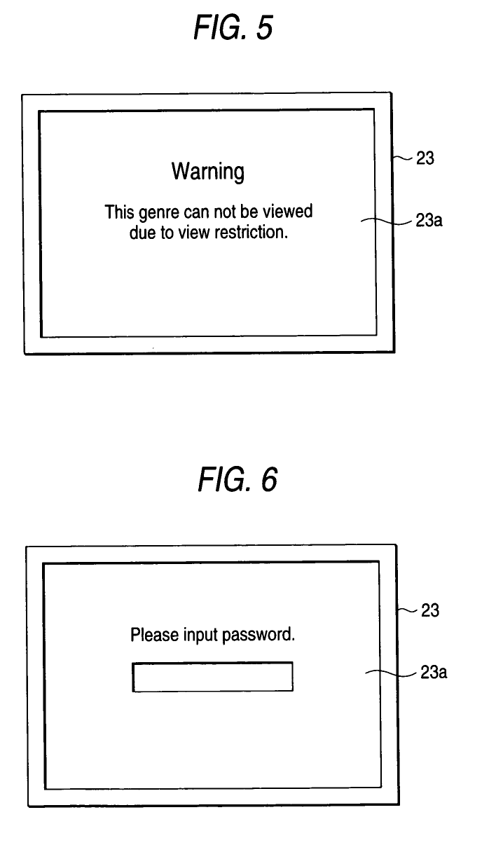

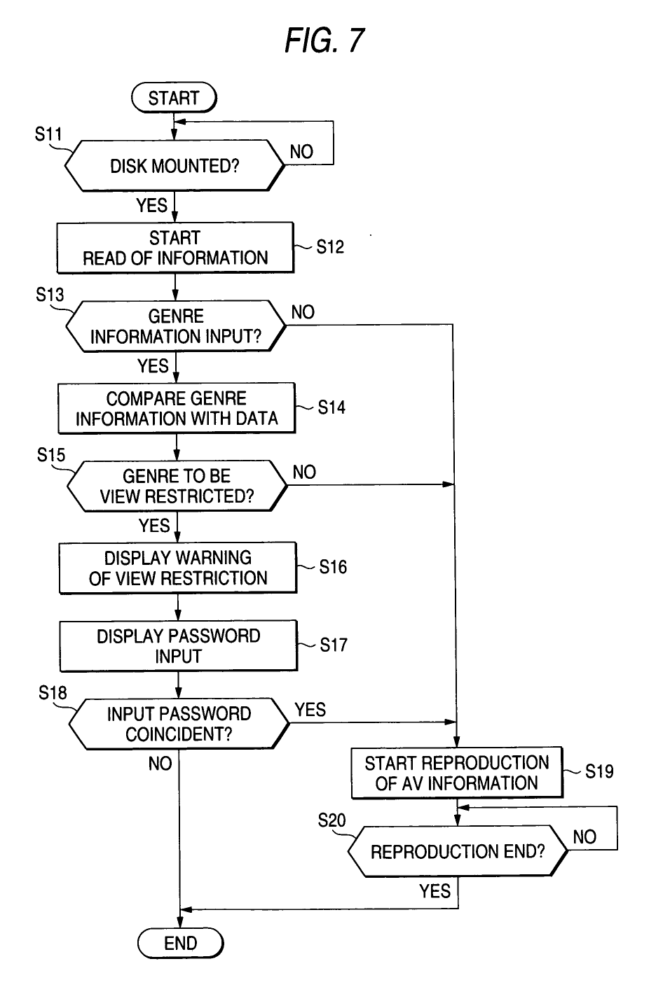

On the other hand, when the genre information from the DVD 1 is one to be restricted, the back-end micro computer 16 controls the OSD circuit to display “WARNING” shown in FIG. 5 on the screen 23a of the monitor 23.

Thus, when a child tries to view the DVD1, the child can be notified the view restriction.

Thereafter, the back-end micro computer 16 displays characters for urging the child to input the password and an input box therefor such as shown in FIG. 6 on the screen 23a of the monitor 23 (Step S17).

When the password is input according to this display, the back-end micro computer 16 compares it with data of the preliminarily registered password to decide whether or not it matches up to the data (Step S18).

When the passwords are not coincident, the reproduction of the AV information is not started and the series of operations of the disk device is ended.

On the other hand, when the password is authenticated, the reproduction of the AV information is started (Step S19).

Then, it is decided whether or not the reproduction is to be ended (Step S20) and the series of operations of the display device is ended at a time when the reproduction is ended.

Therefore, only the user who knows the password can reproduce the DVD 1 and watch it.

A child who does not know the password can not watch the movie due to the view restriction except when he is permitted to watch it by the user.

Incidentally, when the instruction signal is sent from the view restriction key while reproducing the information of the DVD 1, the back-end micro computer 16 controls the system to display the kind of genre of the reproduced information on the screen 23a of the monitor 23.

In such case, after the characters urging a user to input the password are displayed and then the input password is authenticated as shown in FIG. 6, the kind information of genre displayed is stored in the work RAM 17.

Therefore, it is possible for the user to restrict the viewing easily by deciding whether or not the program can be watched by the child while watching the reproduced image.

Incidentally, the disk device of the present invention is not limited to the described embodiments and can be variously modified within the scope of the present invention.

What is claimed is:

1. A disk device for recording required information in or reproducing recorded information from a disk type information recording medium including a read-in area, a user-data area and a read-out area and capable of recording genre of audiovisual information recorded in the user-data area in a block of the read-in area as a text data, comprising:
an input unit for inputting instructions and information related to a recording information in and reproducing information from the disk type information recording medium; and
a control unit for executing a control for stopping reproduction of audiovisual information corresponding to a genre when kind information of the genre inputted by an inputting operation of the input unit and preliminarily recorded in a memory as genre data coincides with kind information of the genre read out from the read-in area during reproduction of information of the disk type information memory medium.

2. The disk device as claimed in claim 1, further comprising:
a display unit for displaying, on a display screen, a genre list and a discrimination sign for determining whether or not the receiving of program of each genre in the genre list is restricted, wherein
when a genre display instruction is sent from the input unit, the control unit controls the display unit to display the genre list and the discrimination sign on the display screen and the genre information determined by the selection operation of the input unit is stored in the memory.

3. The disk device as claimed in claim 1, wherein
the input unit includes a program view restriction key for generating an instruction of program view restriction, the control unit responds to an instruction signal from the program view restriction key during reproduction of information of the disk type information recording medium to display, on the display screen, the kind of genre of the reproducing information and characters for prompting an input of a password and then, when an inputted password is authenticated, to store a kind information of displayed genre in the memory.
